(19) United States
(12) Patent Application Publication
(10) Pub. No.: US 2010/0281778 A1
(43) Pub. Date: Nov. 11, 2010

(54) CAP AND RIM ASSEMBLY FOR SEWER

(75) Inventor: Mayra Jeanett Loya-Morales, Guadalajara (MX)

Correspondence Address: KNOBBE MARTENS OLSON & BEAR LLP, 2040 MAIN STREET, FOURTEENTH FLOOR, IRVINE, CA, 92614, US

(73) Assignee: GRUPO BARGO DE MEXICO, S.A. DE C.V., Guadalajara (MX)

(21) Appl. No.: 12/623,083

(22) Filed: Nov. 20, 2009

(30) Foreign Application Priority Data
Nov. 20, 2008 (MX) MX/A/2008/014775

(51) Int. Cl. E06B 3/38; E05B 65/06

(52) U.S. Cl. 49/394; 29/525.01

(57) ABSTRACT

The invention comprising a cap and rim assembly for sewer or inspection wells, which is characterized by a hermetic closing system due to the configuration of complementary angled flanges provided between the periphery of the cap and the inner seat flange of said rim and a novel safety locking system which prevents the cap from being opened accidentally or intentionally unless a specially designed opening element is used.

### BACKGROUND OF THE INVENTION

1. Field of the Invention

The invention relates to devices to cover a sewer and more specifically it is a new cap and rim assembly to be used as a new design of sewers for networks of urban sanitation.

2. Prior Art

At the present time, different caps and rim assemblies to cover the sewers in an urban sewer network are known. Such caps are vault-shaped and made of metal and although they have fulfilled the purpose of serving as control elements of sewers and manholes in the public roadway, several failures or drawbacks as to their operation and safety have experienced permanently. For example, it is very usual to observe that the cap of the sewers very frequently gets up as a result of the inferior pressure being exerted on them when the drainage system is overflowing with a large water flow or due to the continuous passage of vehicles that causes the cap becomes open or completely separated from the rim, leaving the sewer uncovered with the risk that this represents in the public roadway. To a greater extent, these problems result from an inadequate system fastening the cap to sewer.

In addition to the above problem, the increase of vandalic actions and theft of the metal caps to be sold clandestinely are added. The delayed replacement of said caps from the municipal authorities aggravates the problem because the manhole or sewer remains uncovered for a long time, which represents a risk to the community.

### SUMMARY OF THE INVENTION

A new model of non-metallic sewers having exceptional strength and durability is proposed as a main objective of this invention, the material of said sewer being the result of selecting and treating recovered materials such as: low and high density compacted polyethylene film, high density blown polyethylene, high density injected polyethylene, high and low density ground mass and other similar materials. All these materials are post-industrial and post-consumption materials. Therefore, in addition to the advantages of this invention, manufacture of the sewer helps to preserve the environment because of recycling materials are used to produce an advantageous and very useful product as distinguished from those materials traditionally used in this technical field.

Another objective of this invention is to discourage the traditional theft of this type of accessories because the invention is made of non-metallic material.

Another objective of the invention is to propose a new model of sewer comprising a conical cap and rim design, which provides an easy opening and closing operation thereof; such a design also provides an increased security for maintenance works.

It is another objective of the invention to provide a new sewer having a controlled minimum expansion-contraction as a result of a homogeneous mixture of the used raw materials, the quality of said raw materials and the control of certain process parameters (e.g., temperature used in the manufacture process). Thus, an almost imperceptible value of contraction is achieved even regarding the surrounding concrete, thereby preventing said concrete from separating from the new sewer.

Another innovative feature of the invention is a novel security system hidden in the cap, which is designed to allow the installation and maintenance personal to open easily the sewer and close the latter by simply dropping the cap such that said security system will fasten firmly said cap to the rim. Thus, it is avoided that the sewer remains open (cap unlocked), which occurs very frequently in the conventional systems.

An additional feature of the invention comes from the fact that the new cap and rim assembly for sewers is a completely solid cap member and is made of 100% selected polyethylene, thus the new sewer has excellent mechanical properties such as flexion strength, impact strength and rupture strength; also said assembly has insulation properties and it is 100% anticorrosive. In addition, the new assembly is resistant to collapse and sudden opening so that no metallic structure is required to be included therein.

The above and other objectives are achieved by a preferred embodiment of the invention comprising a cap and rim assembly for sewers, which includes a rim element having an inner periphery consisting in an angled wall to form a conical seat surface, and a cap including a angled peripheral edge coinciding with said conical seat surface of the rim to establish together (cap and rim) a hermetical closure engagement; and a locking mechanism for securing the permanent closure of the sewer by coupling the rim with the cap. The cap can be lifted only by actuating said locking mechanism by means of a special opening element that allows the cap to move hingedly upwards from a closing position to an opening position in which it is possible to enter into the inspection well of the drainage system.

### BRIEF DESCRIPTION OF THE DRAWINGS

FIG. 1 is a perspective view of the cap and rim assembly, shown in closed condition, for sewers of the present invention.

FIG. 2 is a perspective view of the assembly shown in the previous figure, the cap being here shown in open condition.

FIG. 3 is a perspective view of the cap and rim assembly shown diametrically sectioned to allow us to see the locking system of said assembly.

FIG. 4 is a bottom view of the cap in which the specially designed locking system for the invention is shown.

FIG. 5 is a top plan view of the rim element of the invention assembly.

FIG. 6 is a perspective view of the rim element of the present invention.

FIG. 7 is a bottom plan view of the cap element of the invention assembly.

FIG. 8 is a perspective view showing the bottom of the cap of the assembly referred above.

FIGS. 9 and 10 are views illustrating the easy and simple process for opening the sewer by lifting the cap of the present invention by means of the opening element specially designed for the invention.

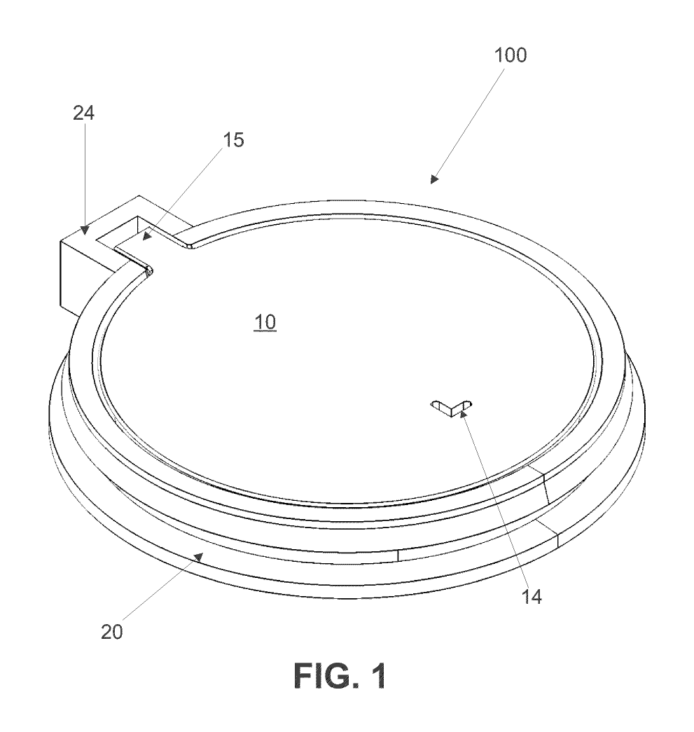

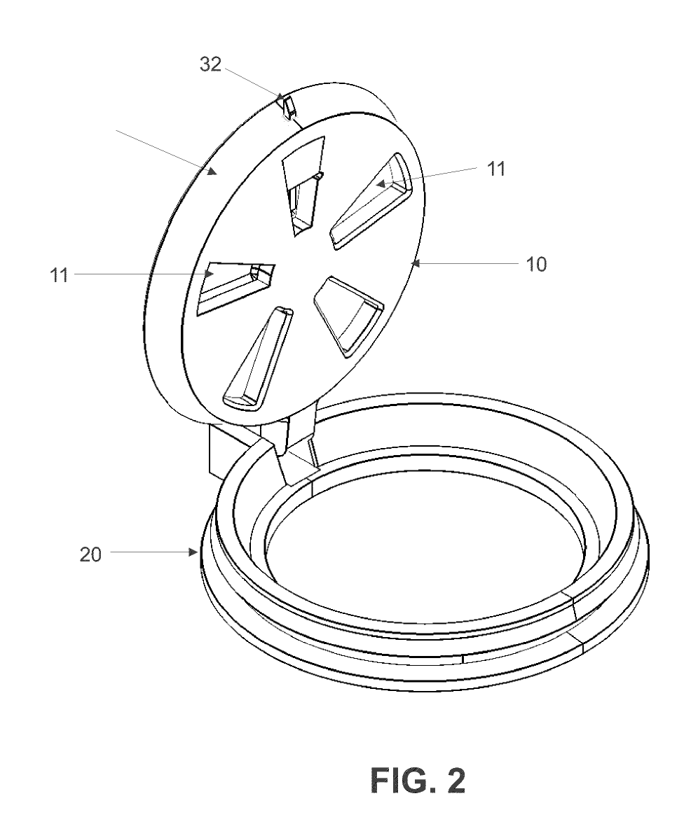

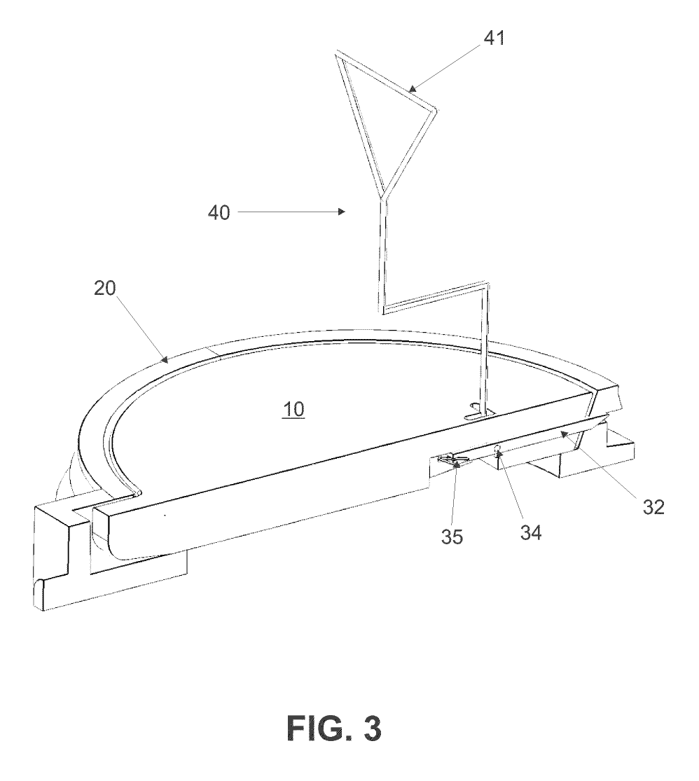

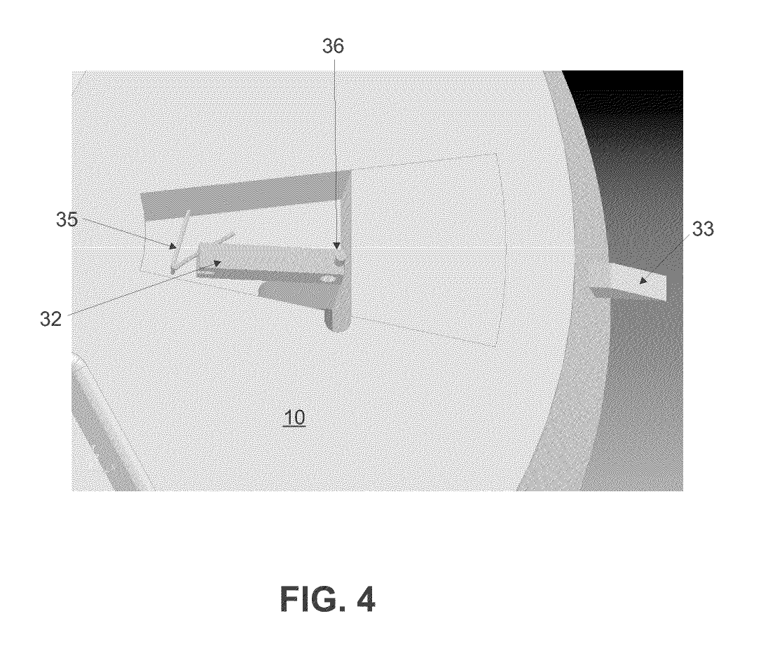

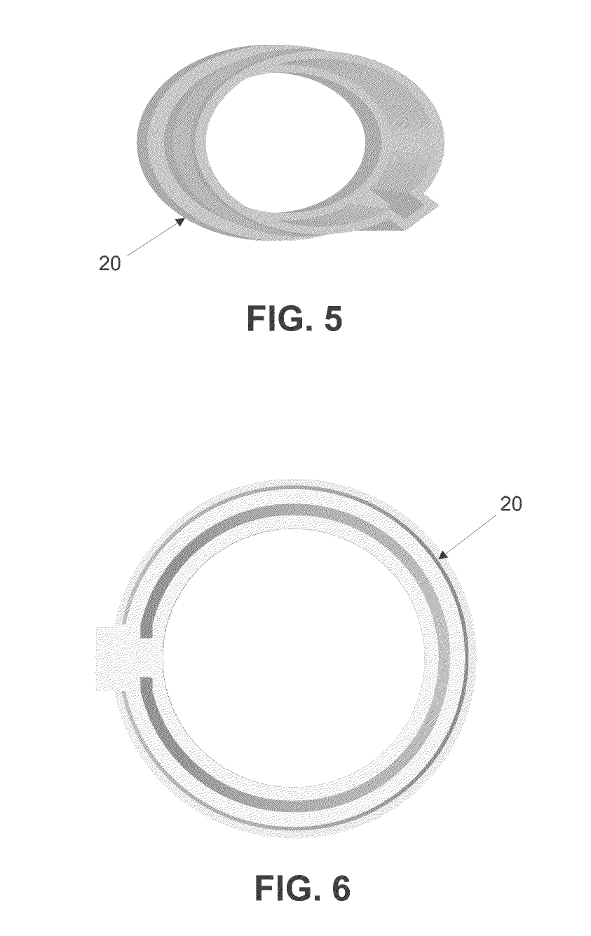

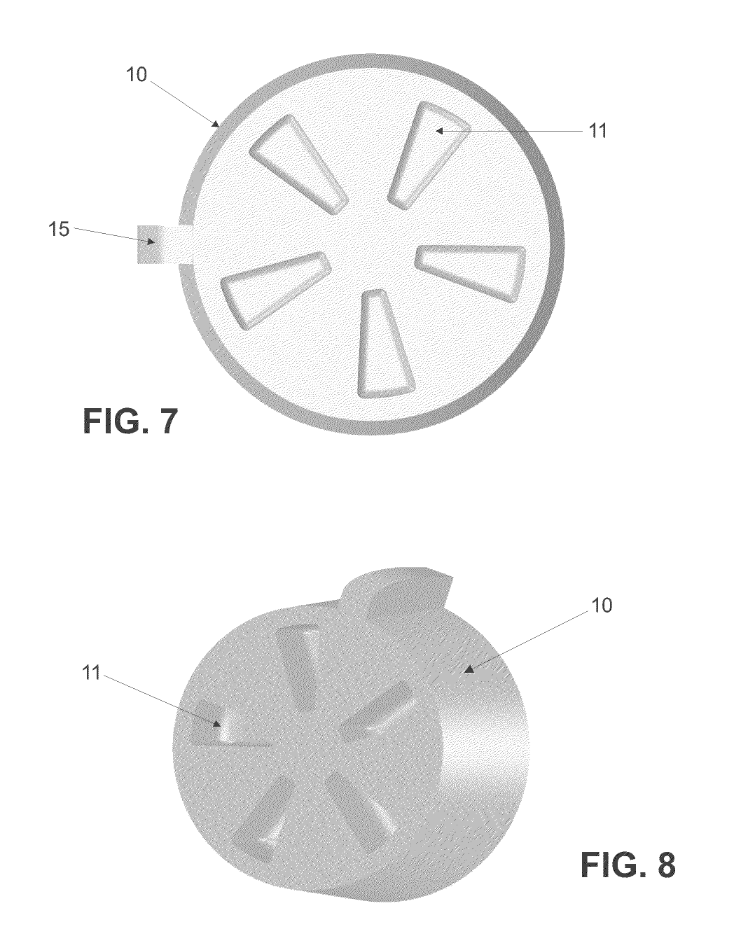

### DETAILED DESCRIPTION OF THE PREFERRED EMBODIMENTS THE INVENTION

With reference to the attached figures, the invention comprises a cap and rim assembly (100) for sewers, which is characterized by incorporating innovations regarding the same type of devices currently used. In principle, the elements of the assembly, i.e. the cap and the rim are not made of metallic materials but rather they are made from recycled polyethylene obtained from recovered materials such as low and high density compacted polyethylene film, high density blown polyethylene, high density injected polyethylene, high and low density ground masses and other similar materials, which are selected and subjected to special treatment described hereinafter.

The cap (10) can be designed in more than one mode or embodiment, for example, preferably said cap may be a completely flat solid member, i.e. not domed, with a plurality of recesses or segments (11) located beneath said cap. In the example case depicted in this specification, a model including at least five recesses (11) has been illustrated without any limitation to other variants that may be adopted for said element of the assembly.

The connection between the cap (10) and the rim (20) is accomplished by means of a U-shaped side flange (24) provided on the periphery of said rim to which a protuberance (15) in said cap is engaged by a pin (not shown), said cap being connected to the rim in such a manner that said cap can move hingedly from the closing position wherein the inspection well or sewer cannot be accessed to an opening position in which said cap can oscillate in an angle not less than 105° when it is lifted to allow the access to the inspection well for maintenance or cleaning works of the drainage system or for helping to drain large volumes of water in case of severe floodings or puddles.

The cap and rim assembly (100) comprises a locking system to keep the cap firmly secured to the rim (20), said locking system (30) including a preferably metallic sliding bolt (32), which is embedded in the cap structure (10). Said bolt has a longitudinal sliding movement, the distal end (33) of the bold is extended beyond the cap periphery for insertion into an orifice (22) in said rim (20) to keep firmly closed the inspection well or sewer. The locking system has an elastic pushing element (35), for example, a torsion spring, anchored to the cap, which is in contact with the rear end of said bolt (32) to keep the latter permanently pushed radially outwards so that the distal end (33) is extended beyond the periphery of the cap. Moreover, said locking system comprises means for limiting the sliding movement, which consists in a pin (36) attached to the bolt, which abuts at the cap to prevent the bolt end from going beyond a certain predetermined distance from the periphery of the angled surface of the cap.

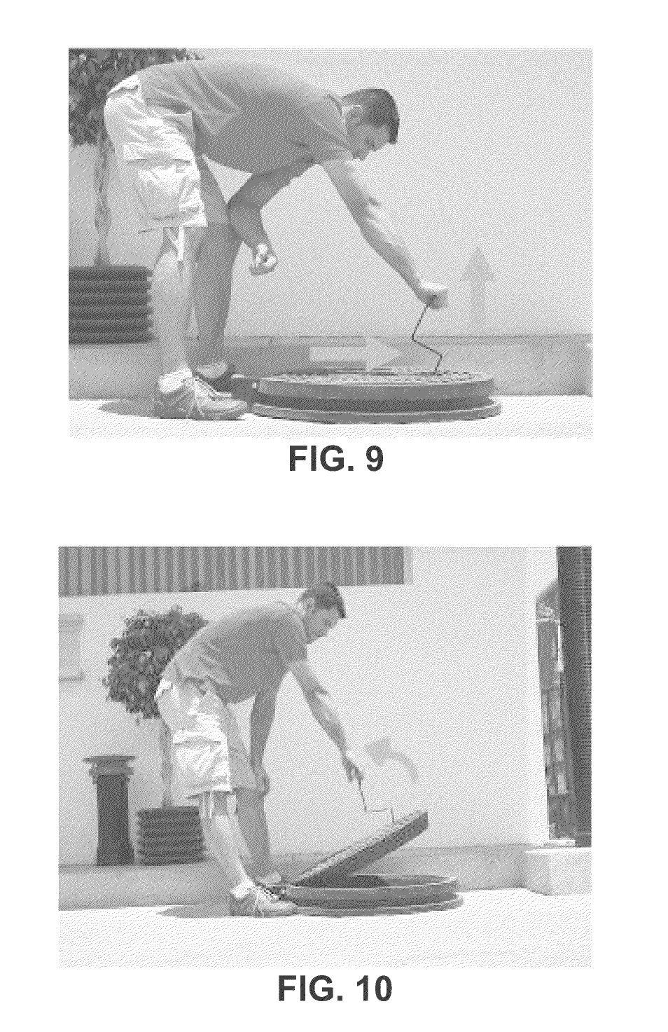

The cap (10) comprises a L-slot (14) at the upper surface thereof into which a specially shaped opening element (40) is inserted; said opening element consisting of lever handle (41) having one end or pivot (not shown) being introduced into said slot (14) to enter into a hole (34) in the sliding bolt (32) of the locking system. Once inserted the pivot into the hole (34), the operator pushes the lever forward (FIG. 9) whereby said bolt (32) slides backward so that its distal end (33) retracts and leaves from the orifice (22) of the rim (20) causing the cap to be uncoupled from the rim. Then, the operator has only to pull the lever upwards to lift the cap (10) of the rim (FIG. 10).

Another feature of the locking system is that the distal end (33) of the sliding bolt (32) has an approximately 45° chamfered tip, like a falling latch of lock, so that when the cap (10) is open, if the latter simply drops it becomes firmly secured to the rim (20) doing unnecessary to follow a special procedure to ensure the closure of the sewer.

The above-described locking system allows opening and closing the cap in faster and easier manner for the authorized personnel by using the lever opening element (40). Thus, the incorporation of a new cap opening and closing system into the invention provides a maximum safety and reliability and makes sure that said cap will not open accidentally due to upward excessive pressure produced by flood of the sewerage network or the pressure generated by vehicle traffic. In both cases, these are situations occurring frequently in the conventional sewer systems and cause accidents because the sewers remain open.

An additional advantage of the new locking system is that it eliminates any possibility that the cap is opened by unauthorized persons, as the locking mechanism is hidden at the bottom of the cap and to open this latter it is required the lever opening element (40) of the type described and illustrated for the present invention.

The cap (10) is further characterized in that its peripheral edge (13) is tapered towards the geometric center of said cap so that its conical design will fit to the cap receiving complementary section (23) of the rim, on which said cap will rest to stablish a closing coupling of the sewer.

Regarding the rim (20) of the new assembly of this invention, said rim comprises a base section from which a section having a first surface angled to the vertical is extended upwardly; said angled surface ends to one of the sides to form a protrusion, wherein this latter and the horizontal surface forms a thinned section. The first angles surface forms the annular seating surface (23) where the cap seats on the rim so as to establish the hermetic coupling with said cap.

### Manufacture Process.

For the manufacture of the constitutive elements of the invention (rim and cap), a careful process starting from the reception, selection, treatment and preparation of the raw material is followed. In a preferred embodiment, said raw material consists in a homogeneous mixture containing approximately 50% of high-density polyethylene and 50% of low-density polyethylene, and 5 parts per thousand of carbon black. Then, the selected mixture is fed to an extruder where the mixed material is carried to be molten and injected to an average temperature of 175° C. in steel molds. The time of filling of the mold for the cap (10) is of approximately 4 minutes and that corresponding to the rim (20) of 2.5 minutes, approximately.

Afterwards, the molds are carried and immersed in water vats at a temperature of 11° C. The cooling time is of 40±5 minutes for the cap (10), and 25±3 minutes for the rim (20); once elapsed the cooling time, the mold is removed from the water and carried to a demolding bank where said cap and the fastening means are removed from the mold. By means of metallic demolding means located at the base of the mold, the injected piece is removed from said mold and is checked visually and then carried to the assembly area, where the processed pieces are checked again and assembled with a galvanized threaded rod 5/16″ diameter and 7″ long fastened on both ends by safety galvanized nuts 5/16″ inner diameter; said rod acting as a hinge element which prevents the cap (10) from separating from the rim (20) when opened.

Also, a galvanized rectangular bolt (32) ½″ wide, ½″ high and 5½″ long, which has a 45° chamfer in the front end (33) and a 5 mm slot along the rear end, is inserted into the cap (10); said bolt being one of the constitutive elements of the locking system that prevents the cap (10) from opening from the sewer accidentally. As described hereinbefore, to push said bolt (32) radially outwardly the cap to a predetermined length, a torsion spring (35) is used; said torsion ring being anchored to the cap to be adjacent to the rear of the bolt (32) for insertion into a bolt slot (36) which acts as a guide to exercise pushing force against the bolt.

In addition to the foregoing features, the invention is characterized in that the cap and rim assembly is the lighter assembly in the market; said assembly having an average weight of 29 kg (63.931 lb) keeping the required strength. The exceptional lightness of the assembly results in a product more easily manipulated and transportable.

Without prejudice to elements illustrated in the accompanying figures, it will be understood that the cap design is not limited in any way to the modes illustrated by way of example in the attached figures.

Although this invention has been described in the context of its preferred embodiment or mode, it will be evident for persons skilled in the art that the scope of the exemplified concept extends beyond the design specifically described and illustrated to other possible and feasible alternative embodiments of the invention. In addition, although the invention has been described in detail, any skilled persons in the invention art may deduce that some constitutive elements of the cap and rim assembly may be replaced or other incorporated in the light of the preceding disclosure without substantially modifying the results thereof.

Taking into account the foregoing, it will be understood that several elements of the assembly can be combined with others or replaced by others to conform alternating ways of accomplishment leading to the same result. Accordingly, it is intended that the scope of the present invention is not construed as limited by the particular embodiment having been described hereinbefore, but rather said scope should be defined by a reasonable reading of the following claims.

1. Cap and rim assembly for sewer of the type comprising a rim conformed on its interior periphery for engagement with a cap for covering the sewer or manhole; said rim having a lateral U-shaped protrusion adapted to receive a lateral protrusion of the cap to be fastened to said rim so that the cap can move hingedly from a horizontal closing position to an opening position in which the cap is lifted to allow accessing inside the manhole; said cap and rim assembly comprising:
a safety locking system for opening and closing the sewer, comprising:
a sliding bolt lodged in the cap in a position oriented radially outward, the distal end of said bolt protruding from the cap edge for insertion into an orifice in the rim when said cap is in closed position;
an elastic pushing element anchored to the cap and adjacent to the rear of the bolt to push it permanently toward the periphery of said cap; and
a slot on the upper surface of said cap for introduction of an element for opening said cap; said element becomes coupled to the sliding bolt to be retracted toward the center of said cap so that said bolt becomes uncoupled from the rim to allow said cap can be lifted.

2. The cap and rim assembly of claim 1, in which the inner edge of said rim is inclined in a certain angle so as to conform a conical seating area for said cap.

3. The cap and rim assembly of claim 1, in which said cap has an angled peripheral edge complementary to the conical seating surface of the rim to establish a hermetical coupling between said cap and rim.

4. The cap and rim assembly of claim 1, in which the locking system further includes a stop element in said bolt to limit the range of sliding outwardly of said bolt.

5. The cap and rim assembly of claim 1, in which the distal end of said bolt is 45° chamfered to ensure the closure of said cap in said rim by simply dropping said cap.

6. The cap and rim assembly of claim 1, in which said bolt has a hole wherein the tip of the opening element is inserted to retract said bolt so as to lift said cap to open the sewer.

7. The cap and rim assembly of claim 1, in which said rim and said cap are made preferably of a homogenous mixture of 50% of high density polyethylene and 50% of low density polyethylene, and 5 parts per thousand of black carbon.

8. A method of manufacturing the cap and rim assembly of claim 1, said methods comprising:
selecting a homogeneous mixture of 50% of high density polyethylene and 50% low density polyethylene, and portions of 5 thousand of black carbon;
feeding the selected mixture to an extruder where it is transported the mixed material to be molten and injected into steel molds at an average temperature of 175° C.; wherein the time of filling the mold for said cap is of approximately 4 minutes and said rim is of 2.5 minutes, approximately;
cooling the molds by immersing them vats containing water at a temperature of 11° C.; wherein the cooling time is 40±5 minutes, for the cap, and 25±3 minutes for the rim;
demolding the molded cap and rim and inserting the sliding bolt and the other components conforming the safety locking system into said cap.
